(19) United States
(12) Patent Application Publication
(10) Pub. No.: US 2026/0171444 A1
(43) Pub. Date: Jun. 18, 2026

(54) SOLID-STATE HYDROGEN STORAGE DEVICE

(71) Applicants: Hyundai Motor Company, Seoul (KR); Kia Corporation, Seoul (KR)

(72) Inventors: Young Jin Cho, Hwaseong-si (KR); Kyung Moon Lee, Hwaseong-si (KR); Ji Hoon Lee, Hwaseong-si (KR); Won Jung Kim, Hwaseong-si (KR); Dong Hoon Nam, Hwaseong-si (KR)

(21) Appl. No.: 19/249,260

(22) Filed: Jun. 25, 2025

(30) Foreign Application Priority Data
Dec. 17, 2024 (KR) 10-2024-0189161

(51) Int. Cl. H01M 8/04082; H01M 8/04029; H01M 8/04223; H01M 8/04701; H01M 8/0606

(52) U.S. Cl. CPC H01M 8/04216; H01M 8/04029; H01M 8/04268; H01M 8/04731; H01M 8/0606

(57) ABSTRACT

An apparatus may comprise a solid-state hydrogen storage container configured to store solid-state hydrogen supplied from a hydrogen supply source, a fuel cell stack configured to receive hydrogen from the solid-state hydrogen storage container to generate electric power, a hydrogen line configured to connect the hydrogen supply source to the fuel cell stack via the solid-state hydrogen storage container, wherein the hydrogen line is connected to an inlet and an outlet of the solid-state hydrogen storage container to enable storage or discharge of the hydrogen, and a cooling water line connected between a cooling water supply source and the fuel cell stack, wherein the cooling water line is connected to the inlet and the outlet of the solid-state hydrogen storage container.

### CROSS-REFERENCE TO RELATED APPLICATION

This application claims the benefit of priority to Korean Patent Application No. 10-2024-0189161, filed in the Korean Intellectual Property Office on Dec. 17, 2024, the entire contents of which are incorporated herein by reference.

### TECHNICAL FIELD

The present disclosure relates to a solid-state hydrogen storage device that may continuously produce, store, and utilize hydrogen.

### BACKGROUND

The matters described in this Background section are only for enhancement of understanding of the background of the disclosure, and should not be taken as acknowledgment that they correspond to prior art already known to those skilled in the art.

Because hydrogen is in a gaseous state at room temperature and pressure, it is stored in the form of high-pressure gas or liquefied hydrogen or chemically bonded to solid/liquid materials to increase energy density.

A high-pressure gas storage method has the advantage of easily and quickly storing hydrogen by filling hydrogen with a physical pressure difference, and as the compression is applied at higher pressure, the weight storage density increases, so it may be widely applied for mobility. However, the storage density per volume may be low, and there may be a limit to further increasing the pressure to increase the storage capacity.

Although a liquefied hydrogen storage may have a high energy density per volume, such storage may use a lot of energy to liquefy hydrogen to cryogenic temperatures, and 2-3% may be evaporated and lost per day, so a heat insulation technology of the storage may be applied. For the liquefied hydrogen storage, as a specific surface area of the storage increases, a loss due to vaporization of liquefied hydrogen may increase, which is disadvantageous for small-capacity storage. Thus, such liquefied hydrogen storage may not be sufficient as a long-term storage.

A method of storing solid-state hydrogen may be able to safely store hydrogen for a long time as the method is performed at a lower pressure than that of a high-pressure gas method. A storage density of hydrogen may be increased by introducing less energy than that of a method of compressing hydrogen to a high pressure or cooling hydrogen to a cryogenic temperature.

However, production and utilization of hydrogen may require different variations periodically or intermittently depending on the environment.

For example, if hydrogen is only produced, a storage space is required in a hydrogen production facility, and if hydrogen is only discharged, a buffer facility for generating hydrogen is required. However, a technology using these auxiliary facilities may cause fuel efficiency to decrease due to the increased system volume and energy loss.

### SUMMARY

The present disclosure has been made to solve the above-mentioned problems.

According to the present disclosure, an apparatus may comprise a solid-state hydrogen storage container configured to store solid-state hydrogen supplied from a hydrogen supply source, a fuel cell stack configured to receive hydrogen from the solid-state hydrogen storage container to generate electric power, a hydrogen line configured to connect the hydrogen supply source to the fuel cell stack via the solid-state hydrogen storage container, wherein the hydrogen line is connected to an inlet of the solid-state hydrogen storage container and an outlet of the solid-state hydrogen storage container such that the hydrogen passes via the solid-state hydrogen storage container to enable storage or discharge of the hydrogen, and a cooling water line configured to be connected between a cooling water supply source and the fuel cell stack, wherein the cooling water line is connected to the inlet of the solid-state hydrogen storage container and the outlet of the solid-state hydrogen storage container to supply or discharge cooling water to or from the solid-state hydrogen storage container.

The apparatus, wherein the hydrogen line may comprise a hydrogen supply line configured to supply the hydrogen from the hydrogen supply source to the solid-state hydrogen storage container, and a hydrogen discharge line configured to discharge the hydrogen from the solid-state hydrogen storage container to the fuel cell stack.

The apparatus, wherein the cooling water line may comprise a cooling water supply line configured to supply the cooling water for cooling the hydrogen from the cooling water supply source to the solid-state hydrogen storage container, and a cooling water discharge line configured to discharge the cooling water from the solid-state hydrogen storage container to the fuel cell stack.

The apparatus, wherein, the hydrogen line may comprise a first hydrogen line configured to pass via a first container of the solid-state hydrogen storage container, a second hydrogen line configured to pass via a second container of the solid-state hydrogen storage container, and a third hydrogen line configured to pass via a third container of the solid-state hydrogen storage container, and the cooling water line may comprise a first cooling water line configured to pass via the first container, a second cooling water line configured to pass via the second container, and a third cooling water line configured to pass via the third container.

The apparatus, wherein the first container, the second container, and the third container are connected to each other in parallel through the hydrogen line and the cooling water line.

The apparatus, wherein the solid-state hydrogen storage container is configured to receive waste heat generated by the fuel cell stack to discharge the hydrogen, and to supply the discharged hydrogen to the fuel cell stack through the hydrogen line.

The apparatus, wherein the solid-state hydrogen storage container is configured to desorb the hydrogen from an adsorbent through an endothermic reaction.

The apparatus, wherein the cooling water line may comprise a radiator configured to cool the cooling water, a fan motor configured to supply air to a heat dissipating area of the radiator, a cooling water pump configured to circulate the cooling water, and a heater configured to heat the cooling water supplied to the fuel cell stack.

The apparatus, wherein the solid-state hydrogen storage container is configured to, reach, based on a first temperature of the solid-state hydrogen storage container, a maximum pressure of the solid-state hydrogen storage container at which a maximum amount of hydrogen is filled in the solid-state hydrogen storage container, and reach, based on a second temperature of the solid-state hydrogen storage container, a minimum pressure of the solid-state hydrogen storage container at which a maximum amount of hydrogen is discharged from the solid-state hydrogen storage container.

According to the present disclosure, a method performed by an apparatus of a fuel cell system, the method may comprise binding hydrogen to a hydrogen-adsorbing material of a solid-state hydrogen storage of the fuel cell system to store the hydrogen in solid-state form in the solid-state hydrogen storage, supplying heat to the solid-state hydrogen storage to cause hydrogen desorption from the hydrogen-adsorbing material, discharging hydrogen desorbed from the solid-state hydrogen storage to a fuel cell stack of the fuel cell system, and controlling, based on a temperature condition of the solid-state hydrogen storage, storing of hydrogen in the solid-state hydrogen and discharging of hydrogen from the solid-state hydrogen.

The method may further comprise based on all containers of the solid-state hydrogen storage reaching a lower limit threshold pressure during hydrogen discharge, terminating supply of heat to the solid-state hydrogen storage.

The method, wherein the supplying of heat to the solid-state hydrogen storage may comprise transferring waste heat generated by the fuel cell stack to the solid-state hydrogen storage.

The method may further comprise sequentially filling a plurality of containers of the solid-state hydrogen storage with the hydrogen in solid-state form based on respective storage pressures of the plurality of containers.

The method may further comprise sequentially discharging hydrogen from a plurality of containers of the solid-state hydrogen storage based on respective storage discharge pressures of the plurality of containers.

The method may further comprise storing a first portion of hydrogen in solid-state form in a current container of the solid-state hydrogen storage, and based on the current container of the solid-state hydrogen storage reaching an upper limit threshold pressure, storing a second portion of hydrogen in solid-state form in a next container of the solid-state hydrogen storage.

The method, wherein the discharging of hydrogen may comprise discharging a first portion of hydrogen from a current container of the solid-state hydrogen storage, and based on the current container of the storage reaching a lower limit threshold pressure, discharging a second portion of hydrogen from a next container of the solid-state hydrogen storage.

The method may further comprise supplying cooling water to the solid-state hydrogen storage to adjust a temperature condition of the hydrogen-adsorbing material.

The method may further comprise heating cooling water using a heater before supplying the cooling water to the solid-state hydrogen storage during a cold start condition.

The method may further comprise circulating cooling water through a radiator, and cooling the cooling water by supplying air to the radiator.

The method, wherein the hydrogen-adsorbing material may comprise an AB₂based hydrogen storage alloy.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a configuration of a solid-state hydrogen storage device according to an example of the present disclosure;

FIG. 2 shows an example of a hydrogen line of a solid-state hydrogen storage device according to an example of the present disclosure;

FIG. 3 shows an example of a cooling water line of a solid-state hydrogen storage device according to an example of the present disclosure;

FIG. 4 shows an example of flows of hydrogen during storage of hydrogen by a solid-state hydrogen storage device according to an example of the present disclosure;

FIG. 5 shows an example of flows of cooling water during storage of hydrogen by a solid-state hydrogen storage device according to an example of the present disclosure;

FIG. 6 shows an example of flows of hydrogen during discharge of hydrogen by a solid-state hydrogen storage device according to an example of the present disclosure;

FIG. 7 shows an example of flows of cooling water during discharge of hydrogen by a solid-state hydrogen storage device according to an example of the present disclosure;

FIG. 8 shows an example of flows of hydrogen during storage/discharge of hydrogen by a solid-state hydrogen storage device or an amount of discharged hydrogen is large according to an example of the present disclosure is large;

FIG. 9 shows an example of flows of cooling water during storage/discharge of hydrogen by a solid-state hydrogen storage device or an amount of discharged hydrogen is large according to an example of the present disclosure is large;

FIG. 10 shows an example of flows of hydrogen when an amount of filled hydrogen is large during storage/discharge of hydrogen by a solid-state hydrogen storage device according to an example of the present disclosure is large; and

FIG. 11 shows an example of flows of cooling water when an amount of filled hydrogen is large during storage/discharge of hydrogen by a solid-state hydrogen storage device according to an example of the present disclosure is large.

FIG. 12 shows an example computing system (e.g., a computing device of a solid-state hydrogen storage device or any other apparatus).

### DETAILED DESCRIPTION

Hereinafter, some examples of the present disclosure will be described in detail with reference to the accompanying drawings. In adding reference numerals to the components of the drawings, it should be noted that the same components have the same numerals as possible even when they are shown on different drawings. In describing examples of the present disclosure, detailed descriptions associated with well-known functions or configurations will be omitted if they may make subject matters of the present disclosure unnecessarily obscure.

Furthermore, in describing components of examples of the present disclosure, the terms first, second, A, B, (a), (b), and the like may be used herein. These terms are only used to distinguish one component from another component, but do not limit the corresponding components irrespective of the nature, order, or priority of the corresponding components. When it is described that a certain component is “connected to”, “coupled to” or “electrically connected to” a second component, it should be understood that the component may be directly connected or electrically connected to the second component, but a third component may be “connected”, “coupled” or “electrically connected” between the components.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

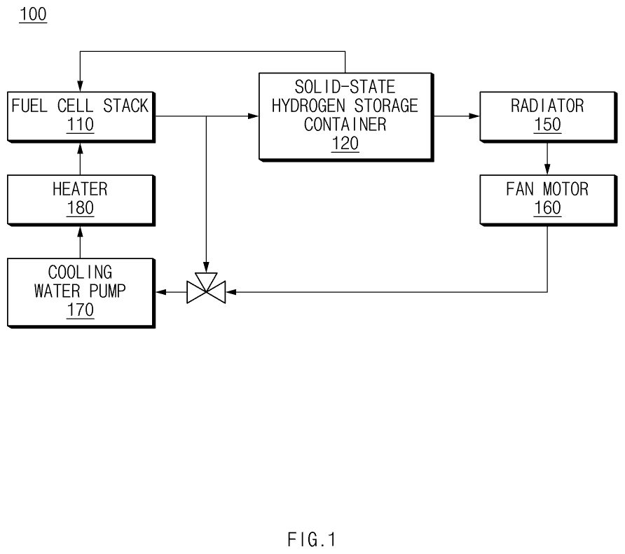

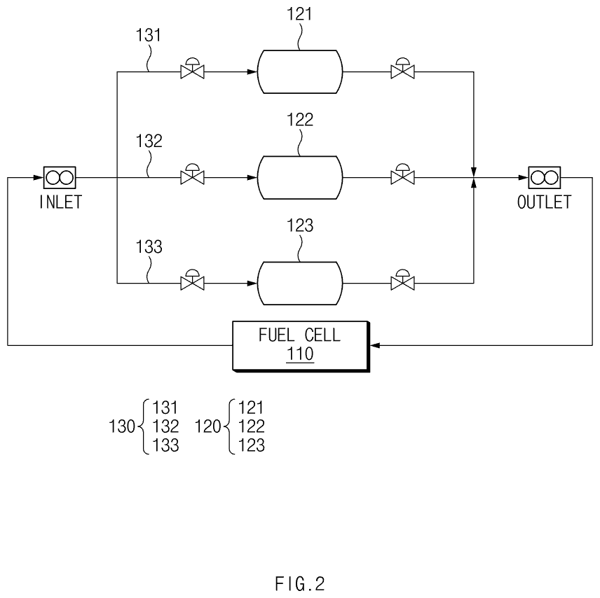

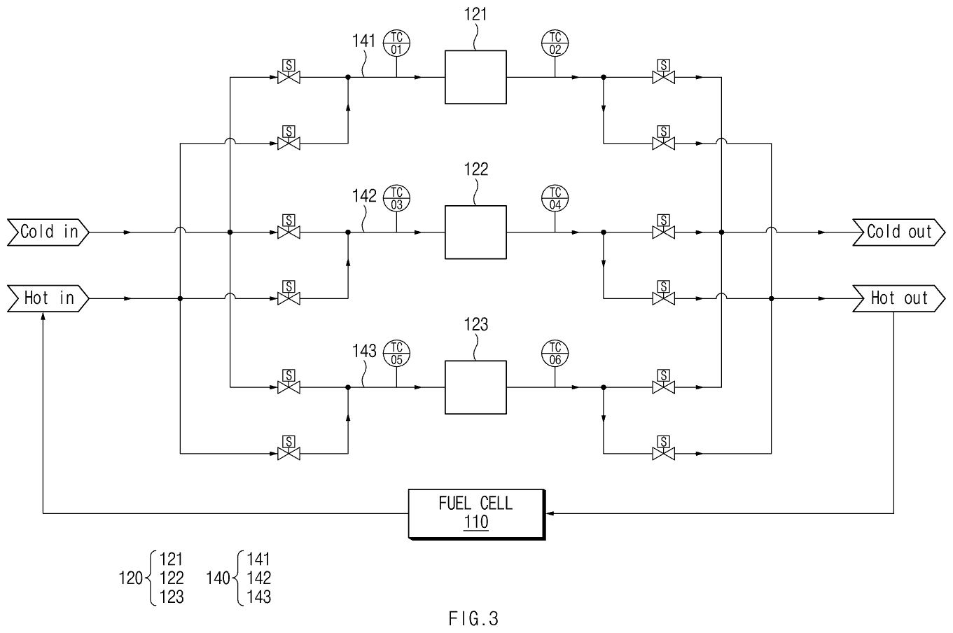

FIG. 1 shows an example of a configuration of a solid-state hydrogen storage device 100 according to an example of the present disclosure. FIG. 2 shows an example of a hydrogen line of a solid-state hydrogen storage device according to an example of the present disclosure. FIG. 3 shows an example of a cooling water line of a solid-state hydrogen storage device according to an example of the present disclosure.

Hereinafter, a solid-state hydrogen storage device 100 according to an example of the present disclosure will be described in detail with reference to the accompanying drawings.

As shown in FIG. 1, the solid-state hydrogen storage device 100 includes a fuel cell stack 110 that receives hydrogen to generate electric power, and a plurality of solid-state hydrogen storage containers 120 that supply hydrogen to the fuel cell stack 110 (e.g., during vehicle operation, off-grid energy supply, or backup power applications, etc.).

Furthermore, a hydrogen supply line for supplying hydrogen from a hydrogen supply source (not shown) to the solid-state hydrogen storage container 120 for storage may be provided between the external hydrogen supply source (not shown) and the fuel cell stack 110 (e.g., upstream of the solid-state hydrogen storage container 120 such as a hydrogen production unit such as a water electrolyzer, steam methane reformer, or metal hydride reactor, etc.). A hydrogen discharge line for discharging hydrogen from the solid-state hydrogen storage container 120 to the fuel cell stack 110 may be provided between the external hydrogen supply source (not shown) and the fuel cell stack 110 (e.g., downstream of the solid-state hydrogen storage container 120 to enable hydrogen delivery for steady-state power generation, backup operation during grid failure, or dynamic load-following in mobile systems, etc.). In an example of the present disclosure, the hydrogen supply line and the hydrogen discharge line are referred to as a hydrogen line 130.

Furthermore, between the external cooling water supply source and the fuel cell stack 110, a cooling water supply line that is connected to an inlet and an outlet to pass via the solid-state hydrogen storage container 120 may be provided to supply cooling water to regulated the temperature (e.g., cool or heat) of hydrogen stored in the solid-state hydrogen storage container 120 (e.g., to assist hydrogen absorption at lower temperatures, promote hydrogen desorption at elevated temperatures, enable cold-start operation, or stabilize thermal cycling in mobile or stationary systems, etc.). A cooling water discharge line for discharging cooling water from the solid-state hydrogen storage container 120 to the fuel cell stack 110 may be provided (e.g., to transfer recovered thermal energy, maintain optimal fuel cell temperature, enable efficient heat exchange, or support hybrid heating strategies during dynamic operating conditions, etc.). In an example of the present disclosure, the cooling water supply line and the cooling water discharge line are referred to as a cooling water line 140 (e.g., to maintain optimal thermal conditions for hydrogen absorption and desorption, prevent overheating of fuel cells, or improve cold start performance, etc.).

The hydrogen line 130 includes a first hydrogen line 131 that is configured to pass through a first container 121 of the solid-state hydrogen storage container 120, a second hydrogen line 132 that is configured to pass through a second container 122 of the solid-state hydrogen storage container 120, and a third hydrogen line 133 that is configured to pass through a third container 123 of the solid-state hydrogen storage container 120 (e.g., to enable sequential filling or discharging of hydrogen based on container pressure levels, temperature conditions, or hydrogen demand, etc.).

Furthermore, the cooling water line 140 includes a first cooling water line 141 configured to pass via the first container 121, a second cooling water line 142 configured to pass via the second container 122, and a third cooling water line 143 configured to pass via the third container 123 (e.g., to regulate the thermal environment individually across each container or in response to dynamic system conditions, etc.).

As an example, a plurality of solid-state hydrogen storage containers 120 may be connected to each other in parallel. Accordingly, it is possible to improve the storage performance and efficiency of hydrogen while storing a large amount of hydrogen by using a solid-state hydrogen storage method (e.g., for high-capacity storage in energy grids, long-duration storage systems, or scalable modular applications, etc.).

Because the cooling water serves as a refrigerant that cools hydrogen in the solid-state hydrogen storage container 120 and the fuel cell stack 110 and is heated by a heater 180 during a cold start mode to be supplied to the solid-state hydrogen storage container 120 and the fuel cell stack 110 as well, it serves as a thermal medium that heats hydrogen in solid-state hydrogen storage container 120 and the fuel cell stack 110 (e.g., enabling desorption under low ambient temperatures, stabilizing fuel cell operation, or supporting rapid system start-up, etc.).

The hydrogen line 130 according to an example of the present disclosure is connected to the solid-state hydrogen storage container 120 between the hydrogen supply source and the fuel cell stacks 110, and the cooling water line 140 is connected to the solid-state hydrogen storage container 120 between the cooling water supply source and the fuel cell stack 110. For example, the hydrogen line 130 and the cooling water line 140 may deliver hydrogen and cooling water, respectively, to the fuel cell stack 110 after passing through the solid-state hydrogen storage container 120, each from its corresponding supply source (e.g., electrolyzer for hydrogen, thermal fluid reservoir for cooling water, etc.).

The present disclosure including such a configuration may include the following additional configurations to supply hydrogen to the fuel cell stack 110 by utilizing waste heat generated from the fuel cell stack 110 (e.g., during steady-state operation, peak load demand, or cold-start sequences, etc.).

A solid-state hydrogen storage device 100 utilizing the waste heat of the fuel cell stack 110 according to an example of the present disclosure will be described.

Water and heat are inevitably generated when a general fuel cell stack 110 generates electricity, and the heat generated in the fuel cell stack 110 reduces efficiency, accelerates material degradation, and imposes thermal stress on components. Therefore, the heat may be discharged while exchanging heat with the outside as waste heat by a cooling medium (e.g., glycol-based coolant, deionized water, or phase-change fluids, etc.).

In the present disclosure, the solid-state hydrogen storage device 100 utilizing the waste heat of the fuel cell stack 110 may improve the thermal efficiency by recycling the waste heat generated from the fuel cell stack 110 when hydrogen is supplied to the fuel cell stack 110.

An adsorbent may be provided in the solid-state hydrogen storage container 120, and hydrogen is adsorbed in the adsorbent. Because the reaction of desorbing hydrogen from the adsorbent is an endothermic reaction, waste heat generated from the fuel cell stack 110 may be supplied to the solid-state hydrogen storage container 120 through the cooling water line 140 (e.g., to facilitate hydrogen release during startup, maintain continuous fuel supply under load, or support thermally regulated cycling in mobile or stationary systems, etc.). Hydrogen desorbed from the adsorbent may be supplied to the fuel cell stack 110 through the hydrogen line 130 (e.g., to enable electricity generation during normal operation, maintain standby readiness, or support rapid response to transient load demands, etc.). A radiator 150 for secondarily cooling the cooling water, a fan motor 160 for supplying a large amount of air to an increased heat dissipation area of the radiator, a cooling water pump 170 for circulating the cooling water in the cooling water line 140, and a heater 180 for heating the cooling water supplied to the fuel cell stack 110 or removing residual hydrogen by thermal purging if the fuel cell-powered system is shut down (e.g., in mobile applications, portable generators, or unmanned devices, etc.) may be further included as shown in FIG. 3.

Next, in the solid-state hydrogen storage device 100 of the present disclosure, a cold start mode will be described.

In the present disclosure, in the solid-state hydrogen storage device 100, in particular, hydrogenation proceeds faster than an increase in hydrogen pressure even if high-pressure filling is performed in a PCT curve that represents a correlation between the storage pressure and the temperature of hydrogen, and an AB₂-based hydrogen storage alloy that maintains a constant internal pressure of the solid-state hydrogen storage container 120 may be used (e.g., Ti-Zr-based AB2 alloys, LaNi5 derivatives, or Mg-based composites, etc.).

Due to the features of hydrogen storage alloy materials that operate at high temperatures, it is necessary to improve performance against a cold start mode when a hydrogen storage alloy is applied to vehicles (e.g., electric buses, hydrogen-powered forklifts, or hybrid military platforms, etc.).

The present disclosure provides a solid-state hydrogen storage device 100 that may improve a cold start performance by utilizing an adsorbent containing a hydrogen storage alloy and perform continuous operations related to production, storage, and power generation.

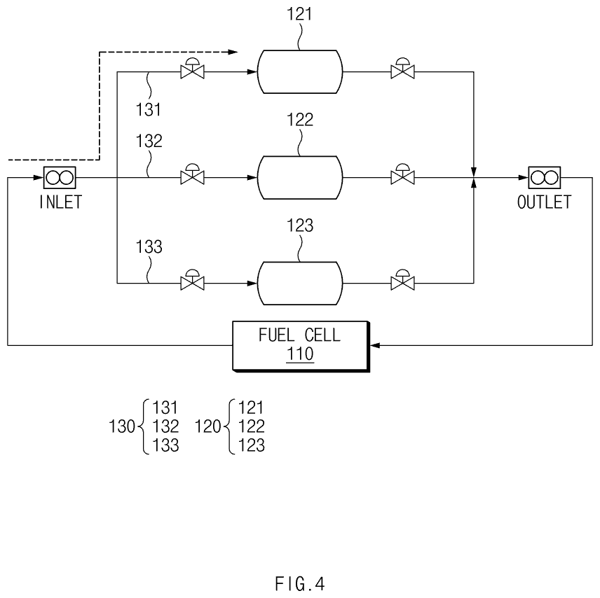

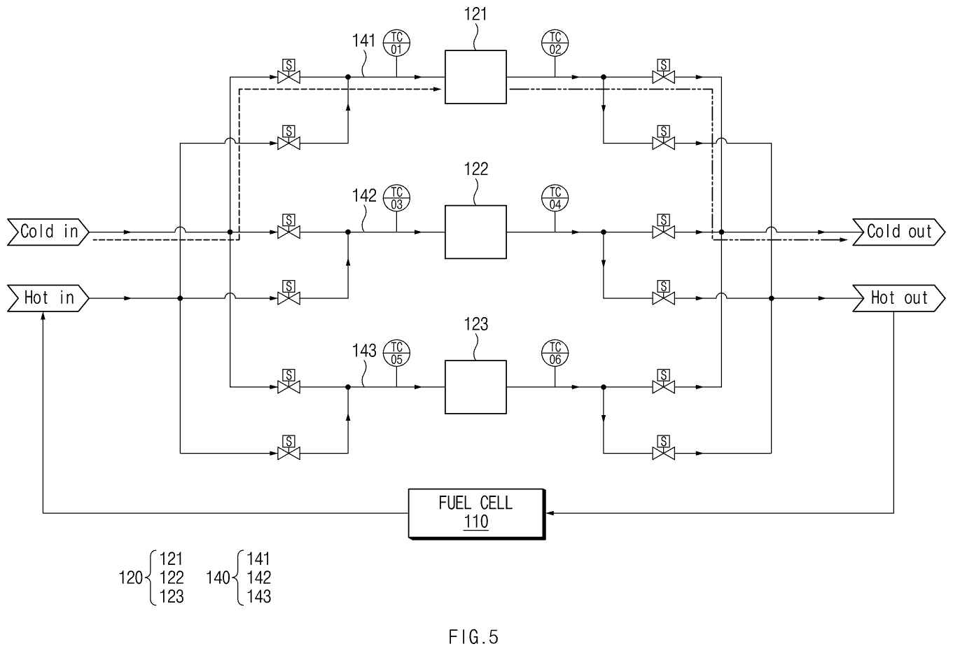

FIG. 4 shows an example of flows of hydrogen during storage of hydrogen by a solid-state hydrogen storage device 100 according to an example of the present disclosure. FIG. 5 shows an example of flows of cooling water during storage of hydrogen by a solid-state hydrogen storage device 100 according to an example of the present disclosure.

Referring to FIGS. 4 and 5, an operation logic that requires filling of hydrogen in the solid-state hydrogen storage container 120 after a standby in a cold start state will be described (e.g., after overnight parking in sub-zero climates or following long-term system shutdown, etc.).

### Operation and Storage of Hydrogen

As shown in FIG. 4, the first container 121 may be opened when hydrogen is supplied to the first container 121 along the hydrogen supply line (e.g., upon system startup, in response to a refill command, or based on a detected pressure by a pressure sensor drop below a threshold, etc.) An amount of filled hydrogen becomes maximal if the storage pressure of the first container 121 reaches a maximum pressure according to temperature, for example, if a maximum pressure of 40 bar is reached at a temperature of 20° C. (e.g., corresponding to the plateau region of the PCT curve for AB2-type alloys, during ambient-temperature refueling, or under controlled thermal charging conditions, etc.). If it is determined that the first container 121 is in a fully filled state, the supply passage may be sequentially changed to the second container 122 and the third container 123 (e.g., based on detected pressure thresholds, flow sensor feedback, or predetermined control logic, etc.). If all of the first to third containers 123 reach the maximum pressure described above, filling of hydrogen to the solid-state hydrogen storage container 120 is ended (e.g., enabling full recharge before peak energy demand or pre-scheduled deployment, etc.).

### Operation and Storage of Cooling Water

As shown in FIG. 5, the first container 121 may be opened when the cooling water is supplied to the first container 121 along the cooling water supply line by the cooling water pump 170 (e.g., to initiate thermal conditioning, support hydrogen absorption, or prepare the container for subsequent hydrogen filling, etc.) An amount of filled hydrogen reaches a maximum if the storage pressure of the first container 121 reaches its corresponding maximum pressure (e.g., determined by the material's hydrogen absorption plateau, ambient temperature conditions, or preset system safety limits, etc.). If it is determined that the first container 121 is in a fully filled state of hydrogen, the supply passage may be sequentially changed to the second container 122 and the third container 123 (e.g., based on sensor-detected saturation levels, time-based control intervals, or automated filling algorithms, etc.) If all of the first to third containers 123 reach the maximum pressure, it is determined that the hydrogen is in a fully filled state in the solid-state hydrogen storage container 120 and cooling of hydrogen by the cooling water is ended (e.g., ensuring thermal stabilization prior to initiating hydrogen discharge or power generation, etc.).

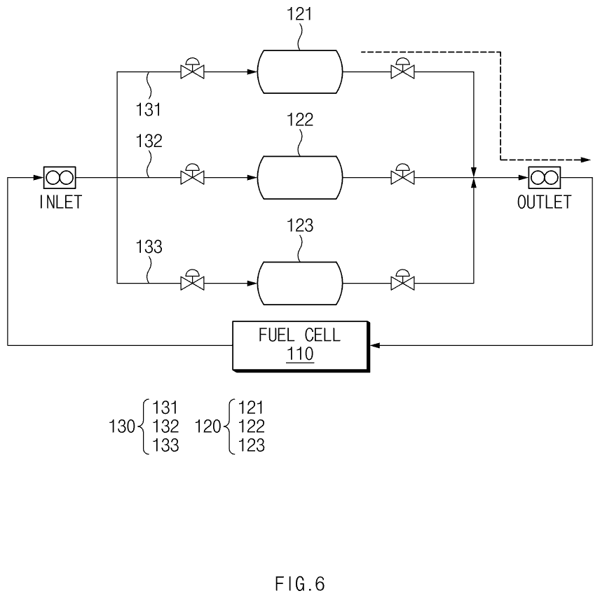

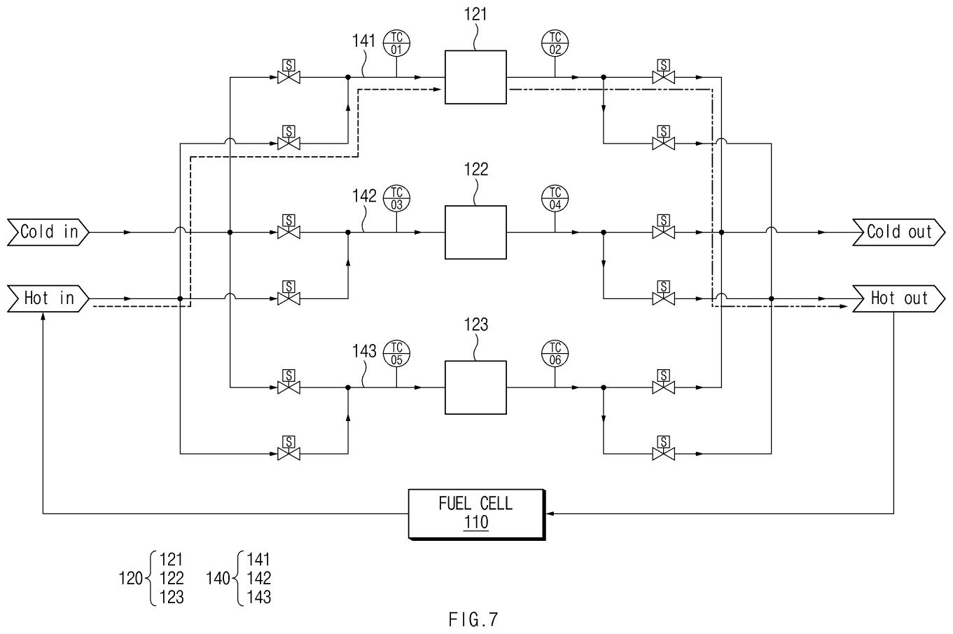

FIG. 6 shows an example of flows of hydrogen during discharge of hydrogen by a solid-state hydrogen storage device 100 according to an example of the present disclosure. FIG. 7 shows an example of flows of cooling water during discharge of hydrogen by a solid-state hydrogen storage device 100 according to an example of the present disclosure.

Referring to FIGS. 6 and 7, an operation logic that requires discharge of hydrogen in the solid-state hydrogen storage container 120 after a standby in a cold start state will be described (e.g., following system boot-up on winter mornings, or after long-duration idle states, etc.).

### Operation and Discharge of Hydrogen

As shown in FIG. 6, hydrogen stored in the first container 121 may be discharged to the fuel cell stack 110 along the hydrogen discharge line. If the storage pressure of the first container 121 reaches a minimum pressure according to temperature, an amount of discharged hydrogen is considered maximal (e.g., corresponding to the lower plateau of the PCT curve, signaling completion of effective desorption, or triggering container switchover in multi-tank systems, etc.). If it is determined that hydrogen in the first container 121 is in a completely discharged state, the discharge passage may be sequentially changed to the second container 122 and then to the third container 123 (e.g., based on pressure sensor feedback, time-based depletion estimates, or automated discharge control logic, etc.) If all of the first to third containers 123 reach the minimum pressure, discharge of hydrogen in the solid-state hydrogen storage container 120 is ended (e.g., enabling full supply cycle prior to container regeneration, or allowing optimized switch-over under fluctuating load conditions, etc.).

### Operation and Discharge of Cooling Water

As shown in FIG. 7, the solid-state hydrogen storage container 120 may be heated by using the heater 180 to facilitate the discharge of hydrogen from the solid-state hydrogen storage container 120 (e.g., by raising the internal temperature to promote endothermic desorption, reduce response time during startup, or maintain flow rate under cold ambient conditions, etc.). If the storage pressure of the first container 121 reaches a minimum pressure according to temperature, an amount of discharged hydrogen is considered to have reached its maximum (e.g., indicating completion of usable hydrogen release, triggering container switchover, or initiating system recharging protocols, etc.). If it is determined that the first container 121 is in a completely discharged state, the discharge passage may be sequentially changed to the second container 122 and then to the third container 123 (e.g., based on pressure threshold detection, flow rate monitoring, or discharge cycle logic executed by a system controller, etc.) If all of the first to third containers 123 reach the minimum pressure, it is determined that hydrogen in the first container 121 is in a completely discharged state (e.g., signaling the end of the supply cycle, prompting system shutdown or refilling, or initiating thermal recovery protocols, etc.) and heating of the cooling water by the heater 180 is ended (e.g., to prevent overheating, reduce unnecessary energy consumption, or initiate a passive standby mode, etc.).

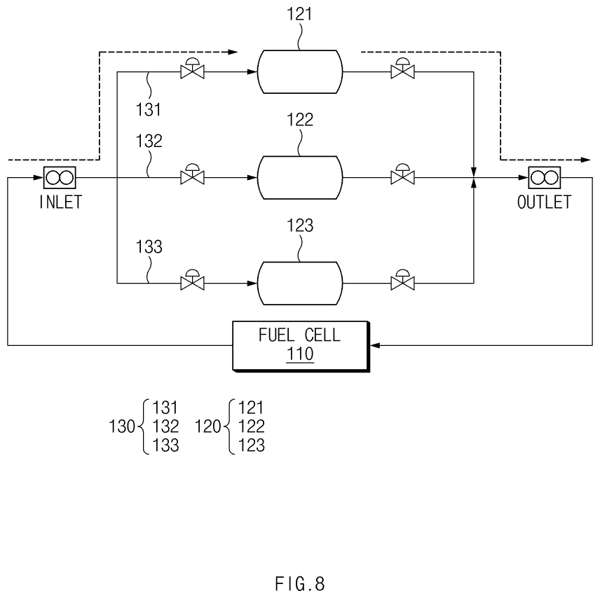

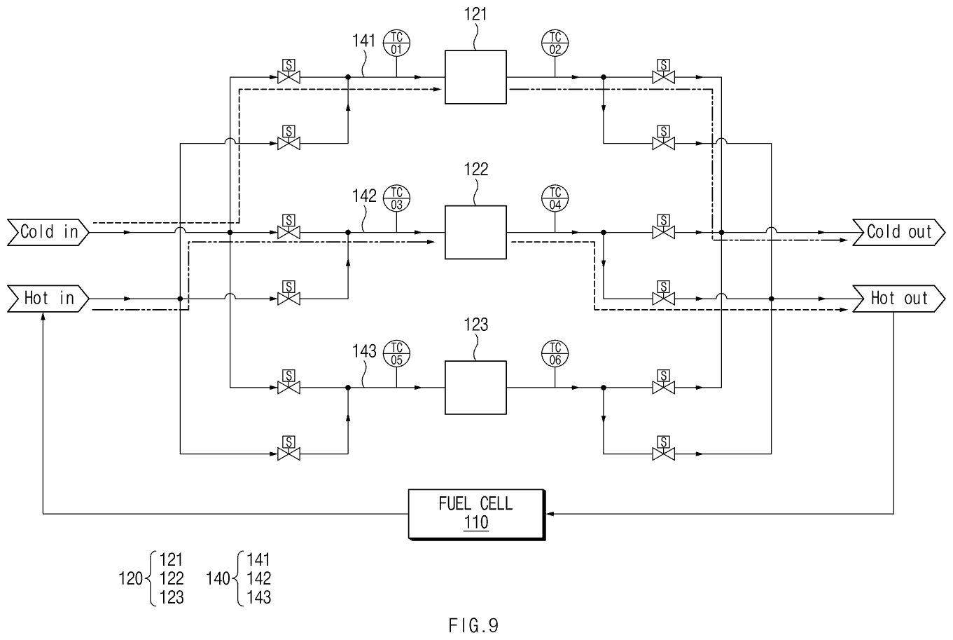

FIG. 8 shows an example of flows of hydrogen during storage/discharge of hydrogen by a solid-state hydrogen storage device 100 or an amount of discharged hydrogen is large according to an example of the present disclosure is large. FIG. 9 shows an example of flows of cooling water during storage/discharge of hydrogen by a solid-state hydrogen storage device 100 or an amount of discharged hydrogen is large according to an example of the present disclosure is large.

Referring to FIGS. 8 and 9, an operation logic during storage/discharge of hydrogen in and from the solid-state hydrogen storage container 120 after standby in a cold start state or when an amount of discharged hydrogen is larger will be described (e.g., in high-demand usage scenarios, peak shaving events, or rapid refill and supply cycles, etc.).

### Operation and Storage of Hydrogen

As shown in FIG. 8, it may be identified that the first container 121 is opened when hydrogen is supplied to the first container 121 along the hydrogen supply line, and an amount of filled hydrogen becomes maximal if the storage pressure of the first container 121 reaches a maximum pressure according to temperature (e.g., 40 bar at 20° C., based on the PCT plateau region of the storage alloy, etc.). If it is determined that hydrogen in the first container 121 is in a fully filled state, the supply passage may be sequentially changed to the second container 122 and then to the third container 123 (e.g., according to control logic triggered by pressure sensors or flow cut-off valves, etc.)If all of the first to third containers 123 reach the maximum pressure, the hydrogen filling process in the solid-state hydrogen storage container 120 is ended (e.g., enabling the system to transition to standby or delivery mode, etc.).

### Operation and Discharge of Hydrogen

As shown in FIG. 8, hydrogen stored in the first container 121 may be discharged to the fuel cell stack 110 along the hydrogen discharge line. If the storage pressure of the first container 121 reaches a minimum pressure according to temperature, an amount of discharged hydrogen is considered maximal (e.g., reflecting the lower desorption limit of the hydrogen storage alloy or triggering automatic switchover, etc.). If it is determined that hydrogen in the first container 121 is in a completely discharged state, the discharge passage may be sequentially changed to the second container 122 and then to the third container 123.

If an amount of stored hydrogen in the first container 121 is larger than an amount of discharged hydrogen, the discharge passage may be sequentially changed to the second container 122 and the third container 123 (e.g., to balance pressure differentials or enable faster hydrogen flow during high-demand conditions, etc.). If all of the first to third containers 123 reach the minimum pressure described above, the hydrogen discharge process for the solid-state hydrogen storage container 120 is ended.

### Operation and Storage of Cooling Water

As shown in FIG. 9, the first container 121 may be opened when the cooling water is supplied to the first container 121 along the cooling water supply line by the cooling water pump 170. An amount of filled cooling water becomes maximal if the storage pressure of the first container 121 reaches a maximum pressure. If it is determined that the first container 121 is in a fully filled state of hydrogen, the supply passage may be sequentially changed to the second container 122 and then to the third container 123. If all of the first to third containers 123 reach the maximum pressure, it is determined that the hydrogen is in a fully filled state in the solid-state hydrogen storage container 120 and the hydrogen cooling process using the cooling water is ended (e.g., ensuring thermal equilibrium prior to desorption, minimizing overcooling, or readying the system for standby, etc.).

### Operation and Discharge of Cooling Water

As shown in FIG. 9, to smoothly discharge hydrogen from the solid-state hydrogen storage container 120, hydrogen stored in the solid-state hydrogen storage container 120 may be promptly discharged using the heated cooling water when the cooling water is heated via the heater 180. The cooling water may be discharged while the cooling water discharge line of the second container 122 is opened (e.g., enabling thermal-assisted desorption, maintaining flow continuity, or balancing container pressures during multi-stage operations, etc.).

Furthermore, because the filling pressure of the cooling water is set to be higher than the discharge pressure of the cooling water, the discharge pressure of the cooling water may be coped with by a differential pressure (e.g., ensuring efficient heat transfer without requiring active pumping during discharge, or enabling passive flow dynamics under low-power conditions, etc.).

If the storage pressure of the first container 121 reaches a minimum pressure according to temperature, it may be identified that an amount of discharged hydrogen is maximal. If it is determined that the first container 121 is in a completely discharged state, the discharge passage may be sequentially changed to the second container 122 and then to the third container 123. If all of the first to third containers 123 reach the minimum pressure and hydrogen in the first container 121 is in a completely discharged state, heating of the cooling water by the heater 180 is ended (e.g., to reduce energy consumption, prevent overheating, or signal readiness for refilling, etc.).

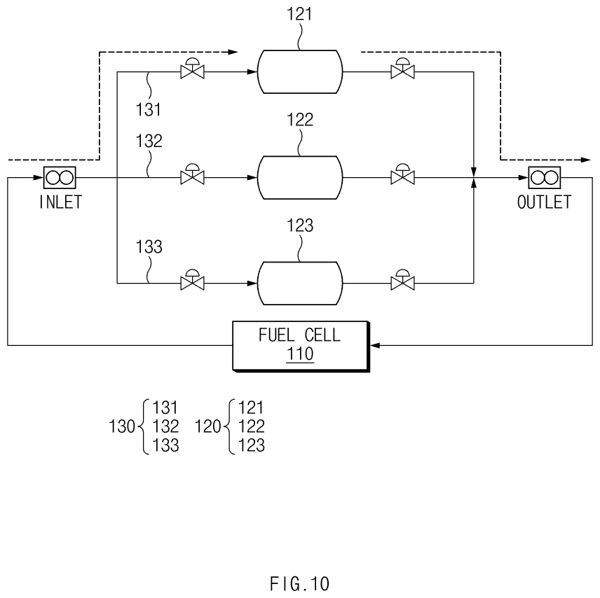

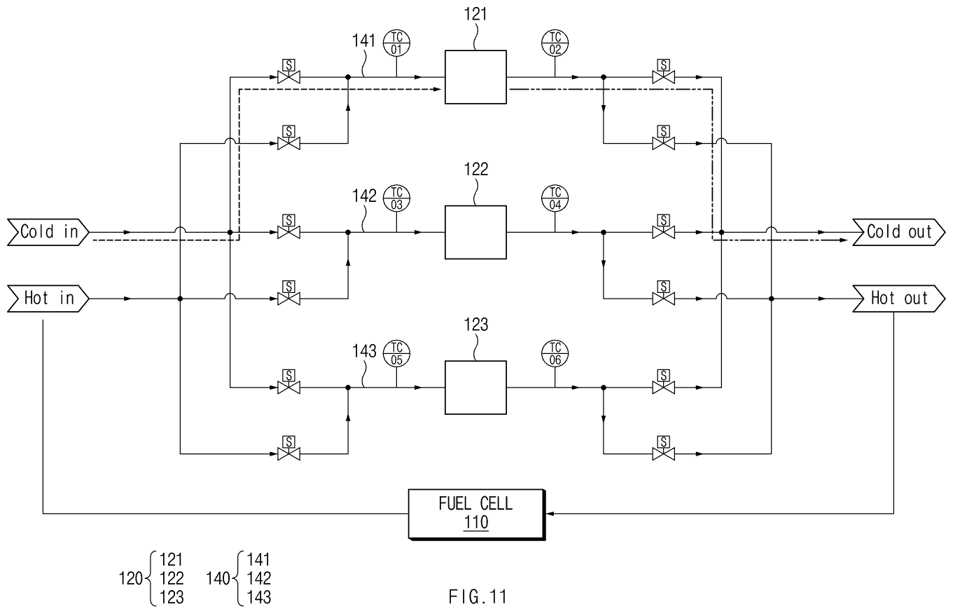

FIG. 10 shows an example of flows of hydrogen when an amount of filled hydrogen is large during storage/discharge of hydrogen by a solid-state hydrogen storage device 100 according to an example of the present disclosure is large. FIG. 11 shows an example of flows of cooling water when an amount of filled hydrogen is large during storage/discharge of hydrogen by a solid-state hydrogen storage device 100 according to an example of the present disclosure is large.

Referring to FIGS. 10 and 11, an operation logic when an amount of filled hydrogen is large during storage/discharge of hydrogen in and from the solid-state hydrogen storage container 120 after standby in a cold start state will be described (e.g., in preparation for peak-demand usage, grid injection, or high-throughput vehicle refueling events, etc.).

### Operation and Storage of Hydrogen

As shown in FIG. 10, the first container 121 may be opened when hydrogen is supplied to the first container 121 along the hydrogen supply line, and an amount of filled hydrogen becomes maximal if the storage pressure of the first container 121 reaches a maximum pressure according to temperature (e.g., corresponding to the absorption plateau of the hydrogen storage alloy, such as 40 bar at 20° C., etc.). If it is determined that hydrogen in the first container 121 is in a fully filled state, the supply passage may be sequentially changed to the second container 122 and then to the third container 123 (e.g., based on pressure threshold logic, flow regulation, or system-defined filling hierarchy, etc.) If all of the first to third containers 123 reach the maximum pressure, the hydrogen filling process in the solid-state hydrogen storage container 120 is ended (e.g., allowing the system to transition to standby or prepare for discharge mode, etc.).

### Operation and Discharge of Hydrogen

As shown in FIG. 10, hydrogen stored in the first container 121 may be discharged to the fuel cell stack 110 along the hydrogen discharge line. If the storage pressure of the first container 121 reaches a minimum pressure according to temperature, an amount of discharged hydrogen is considered to have reached its maximum (e.g., indicating near-complete desorption from the hydrogen storage alloy, triggering container switchover, or marking the end of a discharge cycle, etc.). If it is determined that hydrogen in the first container 121 is in a completely discharged state, the discharge passage may be sequentially changed to the second container 122 and then to the third container 123 (e.g., based on low-pressure detection, discharge flow cutoff, or automated control routines managing container cycling, etc.).

When an amount of stored hydrogen in the first container 121 is larger than an amount of discharged hydrogen, the discharge passage may be sequentially changed to the second container 122 and the third container 123 (e.g., to equalize usage across containers or accelerate supply to the fuel cell under load demand, etc.). If all of the first to third containers 123 reach the minimum pressure described above, the hydrogen discharge process for the solid-state hydrogen storage container 120 is ended.

### Operation and Storage of Cooling Water

As shown in FIG. 11, the first container 121 may be opened when the cooling water is supplied to the first container 121 along the cooling water supply line by the cooling water pump 170. An amount of filled cooling water becomes maximal if the storage pressure of the first container 121 reaches a maximum pressure. If it is determined that the first container 121 is in a fully filled state of hydrogen, the supply passage may be sequentially changed to the second container 122 and then to the third container 123. If all of the first to third containers 123 reach the maximum pressure, it is determined that the hydrogen is in a fully filled state in the solid-state hydrogen storage container 120 and cooling of hydrogen by the cooling water is ended (e.g., indicating readiness for discharge, system idle mode, or thermal equilibrium, etc.).

### Operation and Discharge of Cooling Water

As shown in FIG. 11, if a relatively large amount of hydrogen is filled or discharged, heating of the cooling water by the heater 180 is stopped. This is because the filling pressure of the cooling water is set higher than the discharge pressure of the cooling water, allowing the discharge pressure of the cooling water to be controlled by a differential pressure (e.g., simplifying fluid dynamics, reducing pump load, or enhancing passive heat exchange efficiency, etc.).

Only if the discharge passage is changed to the second container 122 and then to the third container 123 during the cooling water discharge process, the cooling water may be heated (e.g., or reheated) through the heater 180 (e.g., to assist continued desorption, compensate for thermal losses, or stabilize hydrogen flow in the later stages of discharge, etc.).

After hydrogen in the first container 121 reaches a fully filled state, the second container 122 may be filled. In this case, the first container 121 may be heated through the heater 180 to enable smooth discharge of hydrogen in the first container 121 (e.g., avoiding supply interruption during sequential container operation, or accelerating flow response under load, etc.).

As described above, the solid-state hydrogen storage device 100 according to an example of the present disclosure may continuously store and utilize hydrogen in a constant pressure environment by using the hydrogen line 130 and the cooling water line 140 (e.g., ensuring stable supply under varying environmental or load conditions, enabling modular scalability, or supporting hybrid energy systems, etc.).

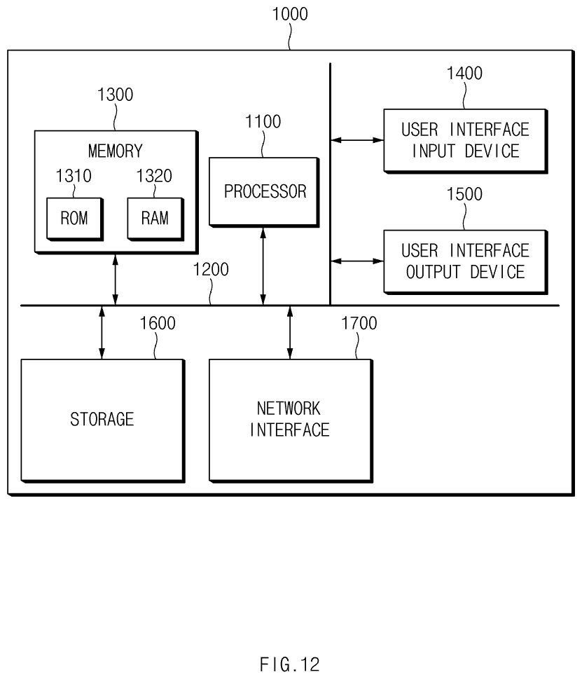

FIG. 12 shows an example computing system (e.g., a computing device of the solid-state hydrogen storage device 100 or any other apparatus). One or more controllers, processors, etc., such as one or more components of the solid-state hydrogen storage device 100, and any other components and devices disclosed herein, may be implemented by or in the computing system as shown in FIG. 12.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

An example of the present disclosure provides a solid-state hydrogen storage device that may continuously store and utilize hydrogen under a constant pressure environment.

An example of the present disclosure also provides a solid-state hydrogen storage device may supply hydrogen to a fuel cell stack by utilizing waste heat that is inevitably generated during a power generation process of the fuel cell stack.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, a solid-state hydrogen storage device includes a solid-state hydrogen storage container that stores solid-state hydrogen supplied from a hydrogen supply source, a fuel cell stack that receives the hydrogen from the solid-state hydrogen storage container to generate electric power, a hydrogen line connected to the hydrogen supply source and the fuel cell stack therebetween, and connected to an inlet and an outlet of the solid-state hydrogen storage container such that the hydrogen passes via the solid-state hydrogen storage container to store or discharge the hydrogen, and a cooling water line connected to a cooling water supply source and the fuel cell stack therebetween, and connected to the inlet and the outlet of the solid-state hydrogen storage container to supply or discharge cooled cooling water to or from the solid-state hydrogen storage container.

According to an example of the present disclosure, the hydrogen line may include a hydrogen supply line that supplies the hydrogen from the hydrogen supply source to the solid-state hydrogen storage container, and a hydrogen discharge line that discharges the hydrogen from the solid-state hydrogen storage container to the fuel cell stack.

According to an example of the present disclosure, the cooling water line may include a cooling water supply line that supplies the cooling water for cooling the hydrogen from the cooling water supply source to the solid-state hydrogen storage container, and a cooling water discharge line that discharges the cooling water from the solid-state hydrogen storage container to the fuel cell stack.

According to an example of the present disclosure, the hydrogen line and the cooling water line may include a first line that passes via a first container of the solid-state hydrogen storage container, a second line that passes via a second container of the solid-state hydrogen storage container, and a third line that passes via a third container of the solid-state hydrogen storage container.

According to an example of the present disclosure, a plurality of solid-state hydrogen storage container may be provided, and may be connected to each other in parallel through the hydrogen line and the cooling water line.

According to an example of the present disclosure, the solid-state hydrogen storage container may be configured to absorb waste heat generated in the fuel cell stack to discharge the hydrogen, and to supply the discharged hydrogen to the fuel cell stack through the hydrogen line.

According to an example of the present disclosure, the solid-state hydrogen storage container may be configured to desorb the hydrogen from an adsorbent through an endothermic reaction.

According to an example of the present disclosure, the cooling water line may include a radiator that cools the cooling water, a fan motor that supplies a large amount of air to an increased heat dissipating area of the radiator, and a cooling water pump that circulates the cooling water, and a heater that heats the cooling water supplied to the fuel cell stack.

According to an example of the present disclosure, if a storage pressure of the solid-state hydrogen storage container reaches a maximum pressure according to temperature, an amount of filled hydrogen may be maximal, and if the storage pressure of the solid-state hydrogen storage container reaches a minimum pressure according to temperature, an amount of discharged hydrogen may be maximal.

According to the solid-state hydrogen storage device according to the present disclosure having the above-described configuration, it is possible to continuously store and utilize hydrogen under a constant pressure environment.

It is possible to improve a cooling efficiency in association with power generation of the fuel cell stack together with the addition of the heated cooling water.

Hydrogen may be supplied to the fuel cell stack by utilizing waste heat generated from the fuel cell stack.

The energy efficiency for thermal circulation of the fuel cell stack may be improved, and thus, the overall efficiency of the fuel cell stack may be increased.

The system volume may be reduced, and the capacity and volume of the cooling pump may be reduced.

The above-mentioned description of the present disclosure is intended to be illustrative, and it should be understood by those skilled in the art that the present disclosure may be embodied in other specific forms without departing from the spirit or essential characteristics thereof. Therefore, the above-described examples are examples in all examples, and should be construed not to be restrictive. The scope of the present disclosure is defined by claims to be described below, and it should be interpreted that the scopes or claims of the present disclosure and all modifications or changed forms derived from the equivalent concept are included in the scopes of the present disclosure.

What is claimed:

1. An apparatus comprising:
a solid-state hydrogen storage container configured to store solid-state hydrogen supplied from a hydrogen supply source;
a fuel cell stack configured to receive hydrogen from the solid-state hydrogen storage container to generate electric power;
a hydrogen line configured to connect the hydrogen supply source to the fuel cell stack via the solid-state hydrogen storage container, wherein the hydrogen line is connected to an inlet of the solid-state hydrogen storage container and an outlet of the solid-state hydrogen storage container such that the hydrogen passes via the solid-state hydrogen storage container to enable storage or discharge of the hydrogen; and
a cooling water line configured to be connected between a cooling water supply source and the fuel cell stack, wherein the cooling water line is connected to the inlet of the solid-state hydrogen storage container and the outlet of the solid-state hydrogen storage container to supply or discharge cooling water to or from the solid-state hydrogen storage container.

2. The apparatus of claim 1, wherein the hydrogen line comprises:
a hydrogen supply line configured to supply the hydrogen from the hydrogen supply source to the solid-state hydrogen storage container; and
a hydrogen discharge line configured to discharge the hydrogen from the solid-state hydrogen storage container to the fuel cell stack.

3. The apparatus of claim 1, wherein the cooling water line comprises:
a cooling water supply line configured to supply the cooling water for cooling the hydrogen from the cooling water supply source to the solid-state hydrogen storage container; and
a cooling water discharge line configured to discharge the cooling water from the solid-state hydrogen storage container to the fuel cell stack.

4. The apparatus of claim 3, wherein:
the hydrogen line comprises:
a first hydrogen line configured to pass via a first container of the solid-state hydrogen storage container,
a second hydrogen line configured to pass via a second container of the solid-state hydrogen storage container, and
a third hydrogen line configured to pass via a third container of the solid-state hydrogen storage container; and
the cooling water line comprises:
a first cooling water line configured to pass via the first container,
a second cooling water line configured to pass via the second container, and
a third cooling water line configured to pass via the third container.

5. The apparatus of claim 4, wherein the first container, the second container, and the third container are connected to each other in parallel through the hydrogen line and the cooling water line.

6. The apparatus of claim 1, wherein the solid-state hydrogen storage container is configured to receive waste heat generated by the fuel cell stack to discharge the hydrogen, and to supply the discharged hydrogen to the fuel cell stack through the hydrogen line.

7. The apparatus of claim 6, wherein the solid-state hydrogen storage container is configured to desorb the hydrogen from an adsorbent through an endothermic reaction.

8. The apparatus of claim 6, wherein the cooling water line comprises:
a radiator configured to cool the cooling water;
a fan motor configured to supply air to a heat dissipating area of the radiator;
a cooling water pump configured to circulate the cooling water; and
a heater configured to heat the cooling water supplied to the fuel cell stack.

9. The apparatus of claim 1, wherein the solid-state hydrogen storage container is configured to:
reach, based on a first temperature of the solid-state hydrogen storage container, a maximum pressure of the solid-state hydrogen storage container at which a maximum amount of hydrogen is filled in the solid-state hydrogen storage container, and
reach, based on a second temperature of the solid-state hydrogen storage container, a minimum pressure of the solid-state hydrogen storage container at which a maximum amount of hydrogen is discharged from the solid-state hydrogen storage container.

10. A method performed by an apparatus of a fuel cell system, the method comprising:
binding hydrogen to a hydrogen-adsorbing material of a solid-state hydrogen storage of the fuel cell system to store the hydrogen in solid-state form in the solid-state hydrogen storage;
supplying heat to the solid-state hydrogen storage to cause hydrogen desorption from the hydrogen-adsorbing material;
discharging hydrogen desorbed from the solid-state hydrogen storage to a fuel cell stack of the fuel cell system; and
controlling, based on a temperature condition of the solid-state hydrogen storage, storing of hydrogen in the solid-state hydrogen and discharging of hydrogen from the solid-state hydrogen.

11. The method of claim 10, further comprising, based on all containers of the solid-state hydrogen storage reaching a lower limit threshold pressure during hydrogen discharge, terminating supply of heat to the solid-state hydrogen storage.

12. The method of claim 10, wherein the supplying of heat to the solid-state hydrogen storage comprises transferring waste heat generated by the fuel cell stack to the solid-state hydrogen storage.

13. The method of claim 10, further comprising sequentially filling a plurality of containers of the solid-state hydrogen storage with the hydrogen in solid-state form based on respective storage pressures of the plurality of containers.

14. The method of claim 10, further comprising sequentially discharging hydrogen from a plurality of containers of the solid-state hydrogen storage based on respective storage discharge pressures of the plurality of containers.

15. The method of claim 10, further comprising:
storing a first portion of hydrogen in solid-state form in a current container of the solid-state hydrogen storage; and
based on the current container of the solid-state hydrogen storage reaching an upper limit threshold pressure, storing a second portion of hydrogen in solid-state form in a next container of the solid-state hydrogen storage.

16. The method of claim 10, wherein the discharging of hydrogen comprises:
discharging a first portion of hydrogen from a current container of the solid-state hydrogen storage; and
based on the current container of the storage reaching a lower limit threshold pressure, discharging a second portion of hydrogen from a next container of the solid-state hydrogen storage.

17. The method of claim 10, further comprising supplying cooling water to the solid-state hydrogen storage to adjust a temperature condition of the hydrogen-adsorbing material.

18. The method of claim 10, further comprising heating cooling water using a heater before supplying the cooling water to the solid-state hydrogen storage during a cold start condition.

19. The method of claim 10, further comprising:
circulating cooling water through a radiator; and
cooling the cooling water by supplying air to the radiator.

20. The method of claim 10, wherein the hydrogen-adsorbing material comprises an AB₂based hydrogen storage alloy.
